(19) United States
(12) Patent Application Publication
(10) Pub. No.: US 2023/0247445 A1
(43) Pub. Date: Aug. 3, 2023

(54) MULTIPLE PATH SUPPORT FOR LAYER 3 USER EQUIPMENT TO NETWORK RELAY

(71) Applicant: QUALCOMM Incorporated, San Diego, CA (US)

(72) Inventors: Karthika PALADUGU, San Diego, CA (US); Hong CHENG, Basking Ridge, NJ (US)

(21) Appl. No.: 18/162,000

(22) Filed: Jan. 31, 2023

Related U.S. Application Data
(60) Provisional application No. 63/267,516, filed on Feb. 3, 2022.

(51) Int. Cl. H04W 16/28; H04W 48/16

(52) U.S. Cl. CPC H04W 16/28; H04W 48/16

(57) ABSTRACT

Various aspects of the present disclosure generally relate to wireless communication. In some aspects, a remote wireless communication device may receive an indication to support multiple paths for a protocol data unit (PDU) session. The remote wireless communication device may establish a multi-access PDU (MA-PDU) session with a network entity over a direct path. The remote wireless communication device may configure the MA-PDU session to include an indirect path via a relay wireless communication device and associated with a non-3GPP interworking function (N3IWF). The remote wireless communication device may communicate via the MA-PDU session. Numerous other aspects are described.

### CROSS-REFERENCE TO RELATED APPLICATION

This patent application claims priority to U.S. Provisional Patent Application No. 63/267,516, filed on Feb. 3, 2022, entitled “MULTIPLE PATH SUPPORT FOR LAYER 3 USER EQUIPMENT TO NETWORK RELAY,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for multiple path support for Layer 3 user equipment (UE) to network relay.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a remote wireless communication device. The method may include receiving an indication to support multiple access for a protocol data unit (PDU) session. The method may include establishing a multi-access PDU (MA-PDU) session with a network entity over a direct path. The method may include configuring the MA-PDU session to include an indirect path via a relay wireless communication device and associated with a non-3GPP interworking function (N3IWF). The method may include communicating via the MA-PDU session.

Some aspects described herein relate to a non-transitory computer-readable medium that stores a set of instructions for wireless communication by a remote wireless communication device. The set of instructions, when executed by one or more processors of the remote wireless communication device, may cause the UE to receive an indication to support multiple access for a PDU session. The set of instructions, when executed by one or more processors of the UE, may cause the UE to establish an MA-PDU session with a network entity over a direct path. The set of instructions, when executed by one or more processors of the UE, may cause the UE to configure the MA-PDU session to include an indirect path via a relay wireless communication device and associated with a N3IWF. The set of instructions, when executed by one or more processors of the UE, may cause the UE to communicate via the MA-PDU session.

Some aspects described herein relate to an apparatus for wireless communication. The apparatus may include means for receiving an indication to support multiple access for a PDU session. The apparatus may include means for establishing an MA-PDU session with a network entity over a direct path. The apparatus may include means for configuring the MA-PDU session to include an indirect path via a relay wireless communication device and associated with a N3IWF. The apparatus may include means for communicating via the MA-PDU session.

Some aspects described herein relate to a remote wireless communication device for wireless communication. The remote user equipment may include a memory and one or more processors coupled to the memory. The one or more processors may be configured to receive an indication to support multiple access for a PDU session. The one or more processors may be configured to establish an MA-PDU session with a network entity over a direct path. The one or more processors may be configured to configure the MA-PDU session to include an indirect path via a relay wireless communication device and associated with a N3IWF. The one or more processors may be configured to communicate via the MA-PDU session.

Aspects generally include a method, apparatus, system, computer program product, non-transitory computer-readable medium, user equipment, base station, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating an example of multiple access for a remote UE via a direct path and an indirect path, in accordance with the present disclosure.

FIG. 6 is a diagram illustrating an example of control plane protocol stacks between a remote UE and an interworking function (IWF) for UE-to-network relay access, in accordance with the present disclosure.

FIG. 7 is a diagram of user plane protocol stack between a remote UE and an IWF for UE-to-network relay access, in accordance with the present disclosure.

FIG. 8 is a diagram illustrating an example of signaling associated with a multi-access protocol data unit (MA-PDU) session, in accordance with the present disclosure.

FIG. 9 is a diagram illustrating an example process performed, for example, by a remote UE, in accordance with the present disclosure.

FIG. 10 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

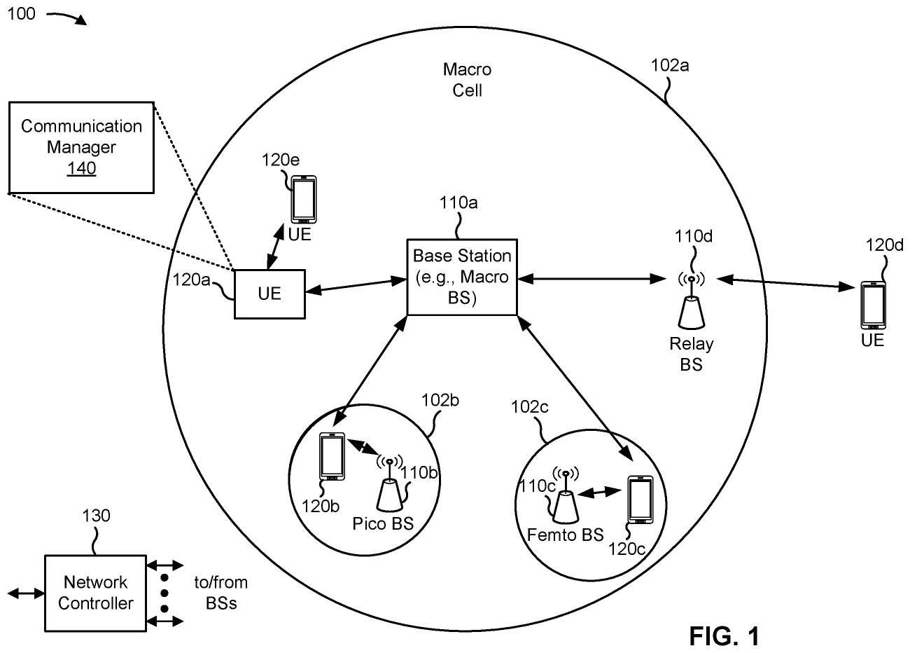

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive an indication to support multiple paths for a protocol data unit (PDU) session; establish a multi-access PDU (MA-PDU) session with a network entity over a direct path; configure the MA-PDU session to include an indirect path via a relay UE and associated with a non-3GPP interworking function (N3IWF); and communicate via the MA-PDU session. Additionally, or alternatively, the communication manager 140 may perform one or more other operations described herein.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a BS (e.g., base station 110), or one or more units (or one or more components) performing base station functionality, may be implemented in an aggregated or disaggregated architecture. For example, a BS (such as a NB, eNB, NR BS, 5G NB, access point (AP), TRP, cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (Dus), or one or more radio units (RUs)). In some aspects, a CU may be implemented within a RAN node, and one or more Dus may be co-located with the CU, or alternatively, may be geographically or virtually distributed throughout one or multiple other RAN nodes. The Dus may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

As indicated above, FIG. 1 is provided as an example. Other examples may differ from what is described with regard to FIG. 1.

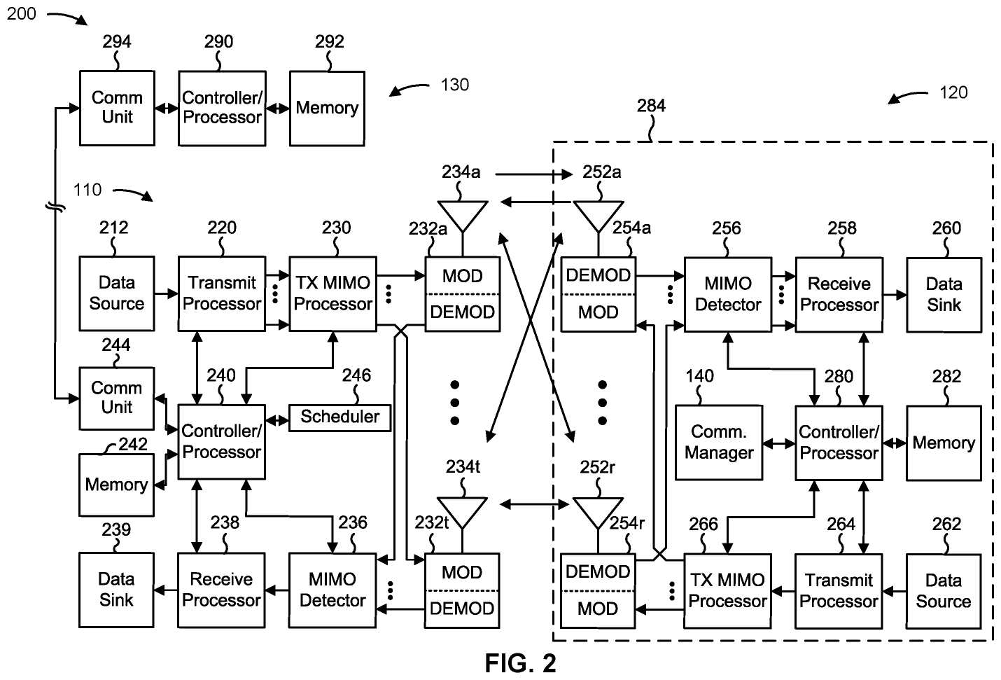

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

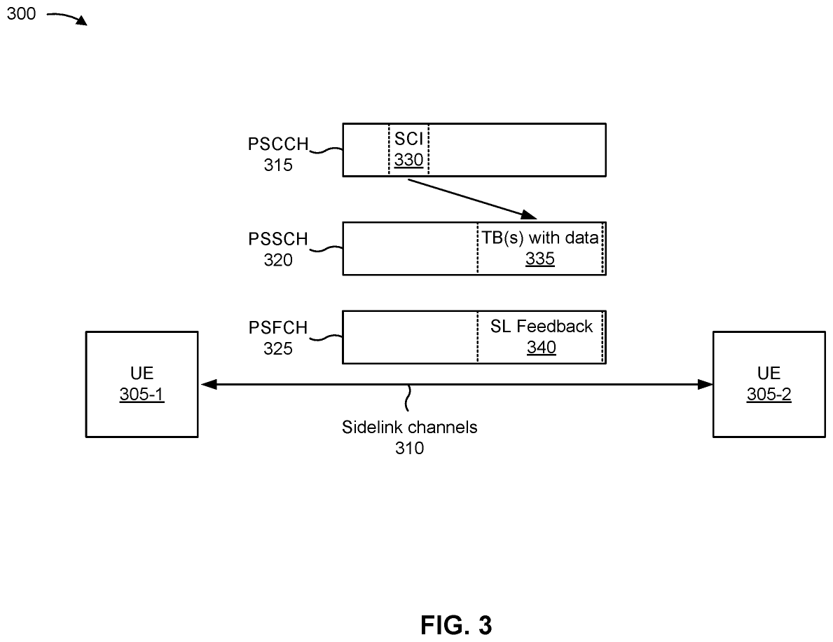

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-10).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-10).

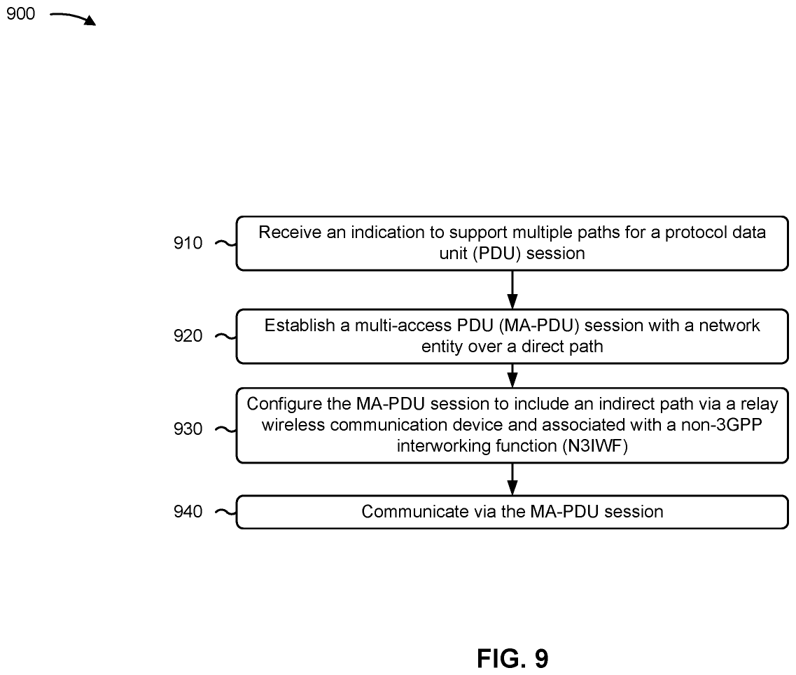

The controller/processor 240 of the base station 110, the controller/processor 280 of the UE 120, and/or any other component(s) of FIG. 2 may perform one or more techniques associated with multiple path support for Layer 3 UE-to-network (U2N) (L3 U2N) relaying, as described in more detail elsewhere herein. For example, the controller/processor 240 of the base station 110, the controller/processor 280 of the UE 120, and/or any other component(s) of FIG. 2 may perform or direct operations of, for example, process 900 of FIG. 9, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 900 of FIG. 9, and/or other processes as described herein. In some examples, executing instructions may include running the instructions, converting the instructions, compiling the instructions, and/or interpreting the instructions, among other examples.

In some aspects, the remote UE includes means for receiving an indication to support multiple paths for a PDU session; means for establishing a MA-PDU session with a network entity over a direct path; means for configuring the MA-PDU session to include an indirect path via a relay UE and associated with an N3IWF; and/or means for communicating via the MA-PDU session. The means for the remote Ueto perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a base station 110 via an access link or an access channel. The PSSCH 320 may be used to communicate data, similar to a physical downlink shared channel (PDSCH) and/or a physical uplink shared channel (PUSCH) used for cellular communications with a base station 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QoS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 320, such as a HARQ process ID, a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a sidelink transmission mode (e.g., Mode 1) where resource selection and/or scheduling is performed by a base station 110. For example, the UE 305 may receive a grant (e.g., in downlink control information (DCI) or in a radio resource control (RRC) message, such as for configured grants) from the base station 110 for sidelink channel access and/or scheduling. In some aspects, a UE 305 may operate using a transmission mode (e.g., Mode 2) where resource selection and/or scheduling is performed by the UE 305 (e.g., rather than a base station 110). In some aspects, the UE 305 may perform resource selection and/or scheduling by sensing channel availability for transmissions. For example, the UE 305 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy rate (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or an MCS to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

In some aspects, a first UE (referred to herein as a relay UE) may relay communications of a second UE (referred to herein as a remote UE) to or from a network (such as a RAN). For example, the relay UE may relay the communications using a U2N relay protocol, as described in more detail elsewhere herein. A path between the remote UE and the network that proceeds via the relay UE is referred to herein as an indirect path, and can be compared to a direct path, which is between the remote UE and a RAN with no relay UE. Techniques described herein provide indication, to the remote UE, of whether to configure a MA-PDU session for a direct path and an indirect path, among other aspects.

As indicated above, FIG. 3 is provided as an example. Other examples may differ from what is described with respect to FIG. 3.

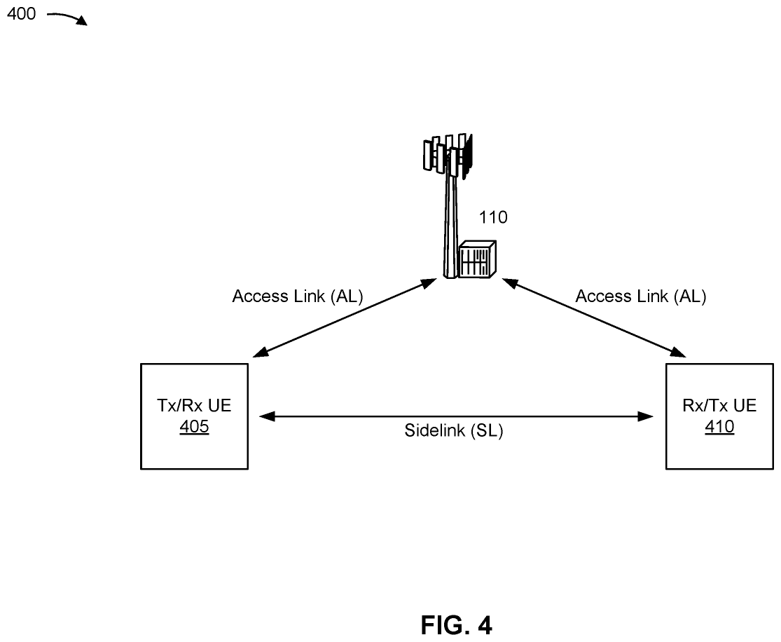

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a base station 110 may communicate with the Tx/Rx UE 405 via a first access link. Additionally, or alternatively, in some sidelink modes, the base station 110 may communicate with the Rx/Tx UE 410 via a second access link. The Tx/Rx UE 405 and/or the Rx/Tx UE 410 may correspond to one or more UEs described elsewhere herein, such as the UE 120 of FIG. 1. Thus, a direct path between UEs 120 (e.g., via a PC5 interface) may be referred to as a sidelink, and a direct path between a base station 110 and a UE 120 (e.g., via a Uu interface) may be referred to as an access link. Sidelink communications may be transmitted via the sidelink, and access link communications may be transmitted via the access link. An access link communication may be either a downlink communication (from a base station 110 to a UE 120) or an uplink communication (from a UE 120 to a base station 110).

As mentioned above, in some aspects, a UE 405/410 may act as a relay UE for a remote UE 405/410. For example, the relay UE and the remote UE may have links with a RAN (such as via an N3IWF for the relay UE). The remote UE may communicate via a direct path (sometimes referred to as a direct link) with the RAN or via an indirect path (sometimes referred to as an indirect link) (that is, via the relay UE and the N3IWF). Techniques described herein provide signaling related to configuring an MA-PDU session for such communication. In some aspects, a direct path may be referred to as a direct network communication path. In some aspects, an indirect path may be referred to as an indirect network communication path.

As indicated above, FIG. 4 is provided as an example. Other examples may differ from what is described with respect to FIG. 4.

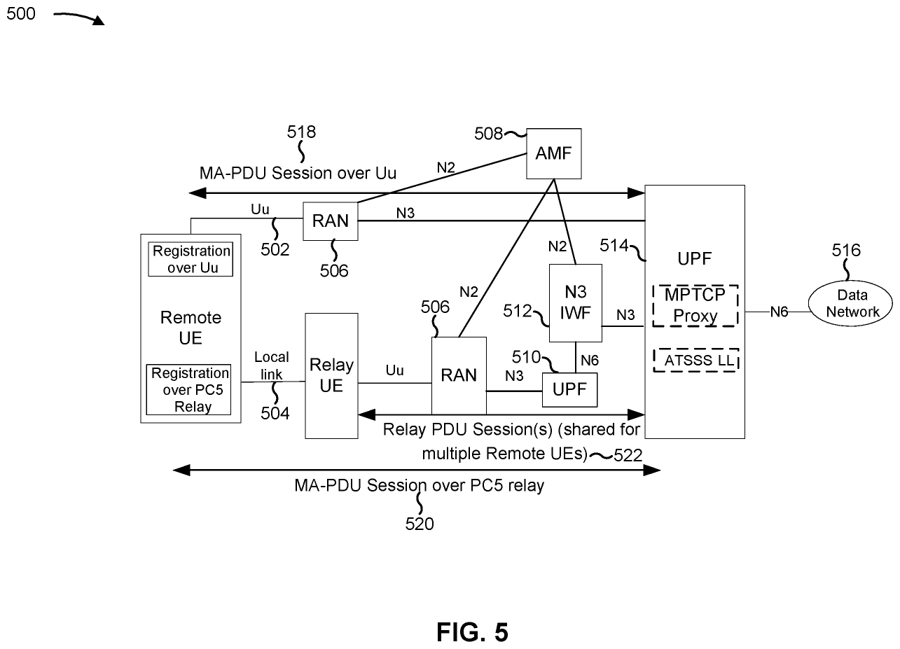

FIG. 5 is a diagram illustrating an example 500 of multiple access for a remote UE via a direct path 502 and an indirect path 504, in accordance with the present disclosure. As shown, example 500 includes a remote UE (e.g., UE 120, UE 305, UE 405, UE 410), and a relay UE (e.g., UE 120, UE 305, UE 405, UE 410). Furthermore, example 500 includes one or more RANs 506, which may include a base station, a CU, a DU, an RU, or a combination thereof. In some aspects, the remote UE and the relay UE may connect to the same RAN 506. In some other aspects, the remote UE and the relay UE may connect to different RANs 506. As shown, example 500 includes an access and mobility management function (AMF) 508, a user plane function (UPF) 510 associated with the indirect path 504, an N3IWF 512, and a UPF 514 associated with a data network 516. AMF 508 includes one or more devices that act as a termination point for non-access stratum (NAS) signaling and/or mobility management, among other examples. UPF 510/514 includes one or more devices that serve as an anchor point for intra-RAT and/or inter-RAT mobility. UPF 510/514 may apply rules to packets, such as rules pertaining to packet routing, traffic reporting, and/or handling user plane quality of service (QoS), among other examples. For example, UPF 514 may handle application or configuration of access traffic steering, switching, and splitting (ATSSS) rules (such as at an ATSSS lower layer (ATSSS LL), multipath transmission control protocol (MPTCP) rules (such as at an MPTCP proxy), or the like). “Network entity” can refer to a RAN 506, an AMF 508, a UPF 510, an N3IWF 512, or a UPF 514.

A direct path 502 is a communication path between a remote UE and a RAN, such as a 3GPP RAN, that includes a radio access link (such as a Uu link) between the remote UE and the RAN. An indirect path 504 is a communication path between the remote UE and a RAN that does not include a radio access link between the remote UE and the RAN. In example 500, the indirect path 504 includes a local link (such as a PC5 link, a sidelink link, a Bluetooth link, a near-field communication link, a WiFi link, or another type of communication link) between the remote UE and a relay UE. The indirect path 504 may also be considered to include one or more of a radio access link between the relay UE and the RAN 506, a link between the RAN 506 and the UPF 510, a link between the UPF 510 and the N3IWF 512, or a link between the N3IWF and the UPF 514. The N3IWF 512 interfaces to 5G core network control plane functions, and may handle routing of messages outside of the 5G RAN. UPF 510 may be considered a UPF of the relay UE, and UPF 514 may be considered a UPF of the remote UE. In some aspects, the direct path 502 may be considered a 3GPP access link or path, and the indirect path 504 may be considered a non-3GPP access link or path.

In example 500, the relay UE may communicate using a L3 U2N relay protocol, referred to herein as performing L3 U2N relaying. L3 U2N relaying is based at least in part on an L3 identifier, such as an Internet Protocol (IP) layer identifier of a destination and/or source of relayed traffic. L3 U2N relaying may utilize an IP layer of the relay UE. For example, the IP layer may handle processing (e.g., routing) of relayed traffic.

Data network 516 includes one or more wired and/or wireless data networks. For example, data network 516 may include an IP multimedia subsystem (IMS), a public land mobile network (PLMN), a local area network (LAN), a wide area network (WAN), a metropolitan area network (MAN), a private network such as a corporate intranet, an ad hoc network, the Internet, a fiber optic-based network, a cloud computing network, a third party services network, an operator services network, a standalone non-public network, and/or a combination of these or other types of networks.

As shown by reference numbers 518 and 520, the remote UE may be associated with an MA-PDU session. A PDU session defines the association between the remote UE and the data network 516 that provides a PDU connectivity service. A PDU session may be identified by a PDU session identifier, and may include one or more quality of service (QoS) flows and QoS rules. A non-MA-PDU session can be established over either a direct path 502 or an indirect path 504. An MA-PDU session is a PDU session that is established over a direct path 502 and an indirect path 504. An MA-PDU session facilitates communication via the direct path 502 (directly between the remote UE and the RAN 506), the indirect path 504 (via the relay UE), or both (e.g., simultaneously).

As shown by reference number 522, in some aspects, the relay UE may have one or more PDU sessions with the UPF 514. For example, a PDU session with the UPF may be shared for multiple remote UEs. In some aspects, the relay UE's PDU session may be an MA-PDU session, and the relay UE may have an indirect path to the RAN 506 via another relay UE. In other words, techniques described herein can be used in the case where multiple relay UEs are situated between a remote UE and the RAN.

Techniques and apparatuses described herein enable signaling of whether to establish an MA-PDU session for the remote UE. Furthermore, techniques and apparatuses described herein provide discovery of a relay UE based at least in part on such signaling, and traffic handling via ATSSS rules.

As indicated above, FIG. 5 is provided as an example. Other examples may differ from what is described with regard to FIG. 5.

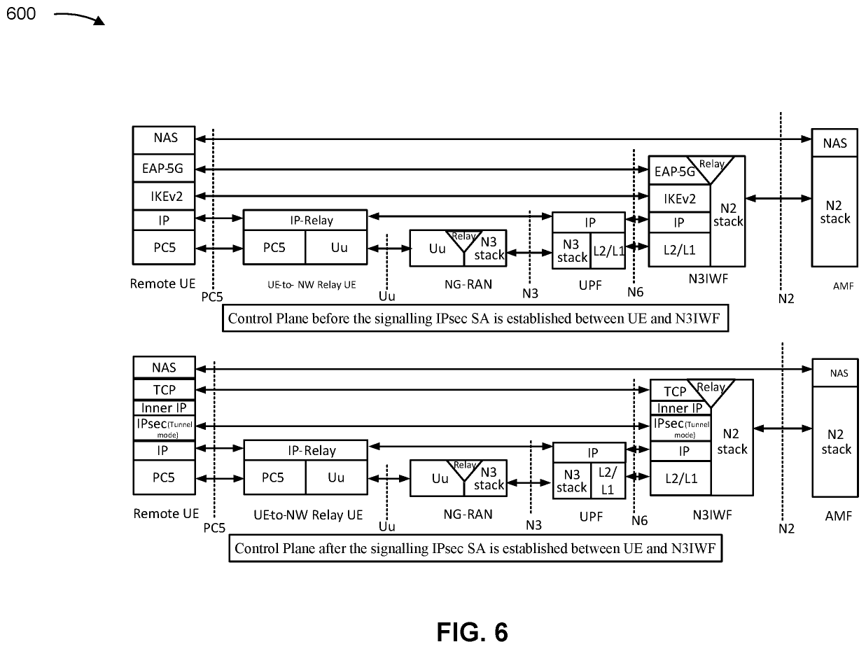

FIG. 6 is a diagram illustrating an example 600 of control plane protocol stacks between a remote UE and an IWF for UE-to-NW relay access. Specifically, a remote UE and the network may support 5G system (5GS) registration and connection management from the remote UE to the network over UE-to-NW Relay access. The remote UE may establish a local connection (in example 600, a PC5 connection) with the UE-to-NW relay and obtain an IP address. The remote UE may then establish an IP security (IPsec) tunnel with the N3IWF over a PC5 relay path (e.g., Internet Key Exchange (IKE) procedures). Similar to untrusted non-3GPP access, subsequent NAS messages between the UE and N3IWF may be exchanged via the signaling IPsec security association (SA) over Transmission Control Protocol/Internet Protocol (TCP/IP) and over Extensible Authentication Protocol 5G (EAP-5G) session. Further, authentication and authorization of a remote UE by 5GC can be supported similar to a radio interface (e.g., Uu). In some implementations, a remote UE may support NAS, EAP-5G, IKEv2 protocols to support 5GS registration and connection management with the 5G core (5GC) over UE-to-NW relay access. Further, in some implementations, a remote UE may discover the N3IWF IP address and support an IPsec tunnel setup with the N3IWF using the IKE procedures over UE-to-NW relay access.

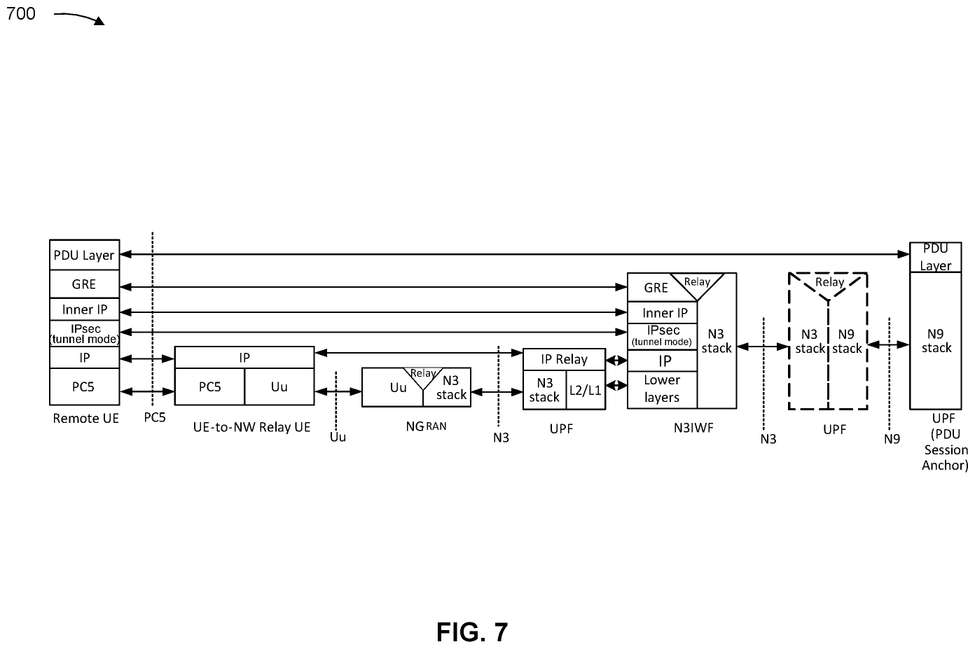

FIG. 7 is a diagram of user plane protocol stack 700 between a remote UE and an IWF for UE-to-NW relay access. The relay UE may carry the remote UE user plane and NAS traffic over relay PDU Session(s) to the N3IWF. The N3IWF may then deliver the data to a UPF.

In some implementations, a remote UE may support PDU Session establishment/modification/release procedures with the 5GC for the remote UE traffic by transporting the PDU session management procedures over the IPsec tunnel established with N3IWF. Further, a remote UE can indicate in the PDU session establishment/modification messages that the PDU Session is for sending traffic via UE-to-NW relay access, by means of a special PDU Request type field. Additionally, a remote UE may transmit/receive the UP traffic over the PDU session(s) established for the remote UE traffic over PC5 UE-to-NW relay path via child Internet Protocol security (IPSec) tunnel to the N3IWF.

As indicated above, FIGS. 6 and 7 are provided as examples. Other examples may differ from what is described with regard to FIGS. 6 and 7.

While FIGS. 3-7 are primarily described in the context of a remote UE and a relay UE, the operations described with regard to FIGS. 3-7 can be implemented by a remote wireless communication device and/or a relay wireless communication device, which may include a UE or another form of wireless communication device.

As described above, a remote wireless communication device, such as a remote UE, may use multiple paths to communicate with a network. For example, the remote wireless communication device may use an MA-PDU session that includes a direct path and an indirect path, where the indirect path includes a Layer 3 U2N relay. However, without a mechanism for indicating whether the remote wireless communication device should establish an MA-PDU session, the remote wireless communication device may establish a non-MA-PDU session when a given UE route selection policy (URSP) rule applies (leading to reduced reliability and single-path communication) or may establish an MA-PDU session when an MA-PDU session is inappropriate, leading to increased overhead and significant resource usage. For example, a URSP rule may indicate whether to support 3GPP access (that is, via a direct path) or non-3GPP access (that is, via an indirect path), but may not be configurable to have a value indicating to use multiple paths (e.g., multiple access) via the direct path and the indirect path.

Some techniques and apparatuses described herein provide indication, to a remote wireless communication device, of whether the remote wireless communication device should support multiple paths (such as via an MA-PDU session) on an indirect path and a direct path. For example, a URSP rule may be enabled to indicate whether the remote UE should support multiple paths (e.g., multiple access). The remote wireless communication device may discover a relay wireless communication device associated with an N3IWF for an indirect path, and may establish an MA-PDU session including the indirect path. In this way, throughput is improved, reliability is improved, and overhead is reduced.

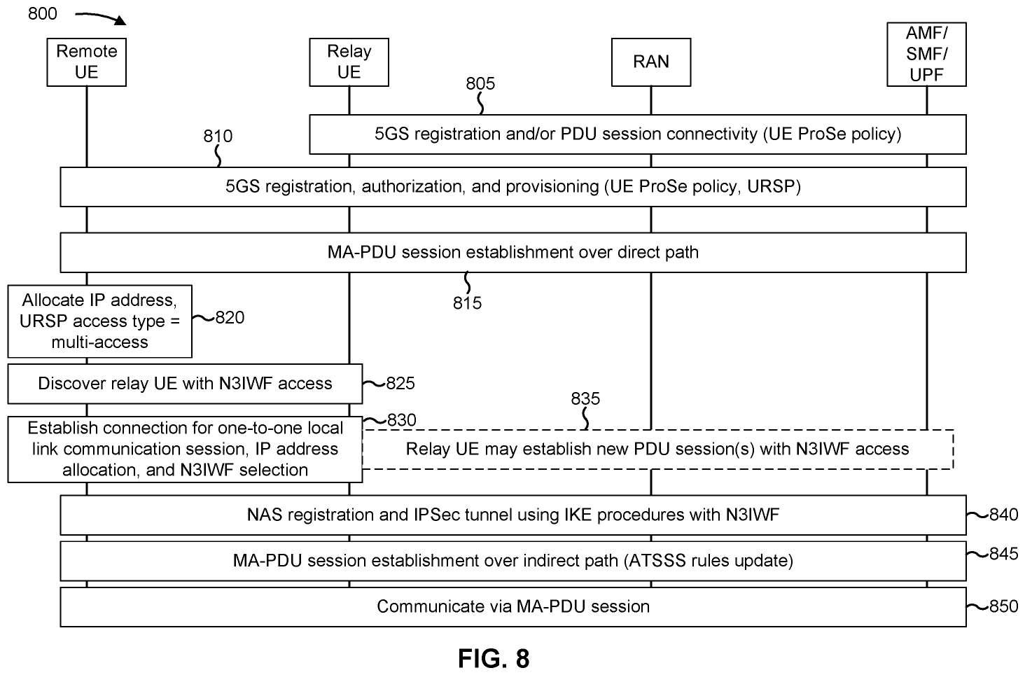

FIG. 8 is a diagram illustrating an example 800 of signaling associated with an MA-PDU session, in accordance with the present disclosure. As shown, example 800 includes a remote UE (e.g., UE 120, UE 305, UE 405, UE 410, the remote UE of FIGS. 5-7), a relay UE (e.g., UE 120, UE 305, UE 405, UE 410, the relay UE of FIGS. 5-7), and a RAN (e.g., base station 110, a CU, a DU, an RU, a next generation RAN (NG-RAN)). Furthermore, example 800 includes an AMF, a session management function (SMF), and a UPF. In some aspects, the remote UE may be associated with a first UPF and the relay UE may be associated with a second UPF. In some aspects, the UPF may support ATSSS functionality. While FIG. 8 is primarily described in the context of a remote UE and a relay UE, example 800 can be implemented by a remote wireless communication device and a relay wireless communication device, which may include a UE and/or another form of wireless communication device.

As shown by reference number 805, the relay UE may perform 5GS registration and/or PDU session connectivity establishment. For example, the relay UE may register with the AMF/SMF/UPF. As another example, the relay UE may establish a PDU session (such as for relaying of remote UE traffic) with the AMF/SMF UPF. In some aspects, the relay UE may be provisioned with a sidelink policy, such as a ProSe policy. For example, a network entity may provide the sidelink policy to the relay UE. The sidelink policy may indicate UE policies for sidelink direct discovery, UE policies for sidelink direct communications (e.g., from UE to UE), and UE policies for U2N relaying, such as L3 U2N relaying.

As shown by reference number 810, the remote UE may perform 5GS registration, authorization, and/or provisioning. For example, the remote UE may register with the AMF/SMF/UPF via a direct path. In some aspects, the remote UE may perform authorization with the AMF/SMF/UPF. In some aspects, the remote UE may be provisioned with a sidelink policy, as described above in connection with reference number 805. For example, a network entity may provide the sidelink policy to the remote UE. In some aspects, the sidelink policy may indicate whether to attempt to discover a relay UE associated with an N3IWF, as described in more detail below. In some aspects, the remote UE may be provisioned with URSP information. For example, a network entity may provide the URSP information to the remote UE. The URSP information (e.g., a URSP policy) may indicate a set of one or more URSP rules. A URSP rule may include a precedence value, a traffic descriptor, a route selection descriptor, or the like. In some aspects, the URSP information may indicate whether to support an MA-PDU session or a non-MA-PDU session. For example, a remote UE access type preference field of the URSP information may be set to a value associated with multiple paths. The value associated with multiple paths may indicate that a PDU session should be established as a PDU session (e.g., may be configured to include a direct path and an indirect path), as described in more detail below.

As shown by reference number 815, the remote UE may establish an MA-PDU session over a direct path (e.g., direct path 502). For example, the remote UE may be an endpoint of the MA-PDU session. The remote UE may establish the MA-PDU session with a network entity such as a UPF. For example, the network entity may establish the MA-PDU session with the remote UE.

As shown by reference number 820, the remote UE may be allocated an IP address. For example, a network entity or a relay UE may allocate the IP address for the remote UE. Furthermore, the remote UE may be associated with an indication to support multiple paths for the MA-PDU session. For example, as described in connection with reference number 810, the remote UE may be provisioned (by a network entity) with URSP information indicating to support multiple paths (e.g., with a value associated with multiple paths). The IP address may be associated with the MA-PDU session. For example, the IP address may be used for both the direct path and the indirect path, as described below.

As shown by reference number 825, the remote UE may discover a relay UE that has N3IWF access. For example, the remote UE may perform a sidelink discovery procedure to discover the relay UE. Sidelink discovery can include Model A discovery or Model B discovery. Model A discovery may include an announcing UE transmitting an announcement message (e.g., broadcast message) that is monitored for by monitoring UEs. Model B discovery may include a discoverer UE transmitting a solicitation message (e.g., broadcast message) to discovered UEs that may transmit a response message. In this example, the relay UE may provide information indicating that the relay UE is associated with an N3IWF (e.g., N3IWF support, N3IWF access) such as in a discovery message (e.g., an announcement message, a solicitation message, a response message) or a separate message. In some aspects, the remote UE may discover the relay UE that has N3IWF access based at least in part on the URSP information indicating to support multiple paths. For example, if the remote UE receives URSP information indicating to support multiple paths, the remote UE may attempt to discover relay UEs that have N3IWF access.

As shown by reference number 830, the remote UE and the relay UE may establish a connection. For example, the remote UE and the relay UE may establish a connection for a local link communication session (e.g., a PC5 link communication session or the like). In some aspects, the relay UE may allocate an IP address (such as for L3 U2N relaying by the relay UE). In some aspects, the relay UE and/or the remote UE may select an N3IWF for an indirect path between the remote UE and a network. As shown by reference number 835, in some aspects, the relay UE may establish a PDU session with N3IWF access. For example, the relay UE may establish a relay PDU session associated with the N3IWF, as described in connection with reference number 522 of FIG. 5.

As shown by reference number 840, the remote UE may perform NAS registration and IPSec tunnel establishment using IKE procedures with the N3IWF. For example, the remote UE may perform NAS layer registration with the AMF for the indirect path. Furthermore, the remote UE may establish an IPSec tunnel using IKE procedures with the N3IWF. Thus, the remote UE has a NAS connection to the 5GC via the N3IWF.

As shown by reference number 845, the remote UE may configure the MA-PDU session to include the indirect path (which may be included in or which may include MA-PDU session establishment over the indirect path). In some aspects, the remote UE may reconfigure the direct path's PDU session to include the indirect path (such that a single PDU session is used on both paths). In some aspects, the remote UE may establish a second PDU session on the indirect path, where the second PDU session is associated with the same IP address as the first PDU session. In such examples, a single MA-PDU session includes a first PDU session on the direct path and the second PDU session on the indirect path.

As further shown, the remote UE may update one or more ATSSS rules. For example, a network entity such as the SMF may provision the one or more ATSSS rules to the UE and/or the UPF. The one or more ATSSS rules may indicate whether traffic should be routed via the direct path or the indirect path. For example, an ATSSS rule may indicate how to steer traffic (e.g., selecting a link or path for user plane traffic based at least in part on a service associated with the user plane traffic), how to switch a link (e.g., how to perform handover of a link or path without service interruption to the remaining link or path), and/or how to split traffic (e.g., how to simultaneously communicate on both links or paths). At reference number 845, the network entity such as the SMF may update the one or more ATSSS rules based at least in part on the MA-PDU session via the indirect path and the direct path.

As shown by reference number 850, the remote UE may communicate via the MA-PDU session. For example, the remote UE may communicate via the indirect path. As another example, the remote UE may communicate via the direct path. In some aspects, the remote UE may communicate based at least in part on one or more URSP rules, as described above. For example, a URSP rule may indicate a traffic descriptor and a corresponding route selection descriptor. If an application or application traffic matches a URSP rule, a corresponding route selection descriptor may be used to evaluate one or more existing PDU sessions, or determine establish a new PDU session, or determine to offload the application or application traffic outside of a PDU session. If the corresponding route selection descriptor does not indicate to offload communication outside of a PDU session, then the remote UE may use the MA-PDU session to route the traffic. For example, if the corresponding route selection descriptor does not contain a “5G ProSe Layer-3 UE-to-Network Relay Offload” indication or “Non-Seamless Offload” indication, the remote UE shall use a PDU session to route the corresponding application traffic. If configured in the sidelink policy to attempt to discover a relay UE associated with an N3IWF, and if the corresponding route selection descriptor indicates to support multiple paths for a PDU data session, the remote UE may attempt the discovery of a relay service code corresponding to a 5G ProSe Layer-3 UE-to-Network Relay with N3IWF support (that is, a L3 U2N relay UE with N3IWF support) in a discovery procedure. Thus, the remote UE may configure an MA-PDU session via the N3IWF when the access type is set to support multiple paths, as described above. The remote UE may use ATSSS rules to handle traffic across the direct path (i.e. 3GPP access) and the indirect path (i.e. non 3GPP access).

In this way, a remote UE can be indicated, such as via URSP information, to support multiple paths for an MA-PDU session. The remote UE can configure the MA-PDU session to include an indirect path and a direct path. The remote UE can use ATSSS rules to handle traffic across the direct path and the indirect path. Thus, reliability of remote UE communications is improved and throughput is increased.

As indicated above, FIG. 8 is provided as an example. Other examples may differ from what is described with regard to FIG. 8.

FIG. 9 is a diagram illustrating an example process 900 performed, for example, by a wireless communication device such as a UE, in accordance with the present disclosure. Example process 900 is an example where the wireless communication device (e.g., UE 120, UE 305, UE 405, UE 410) performs operations associated with multiple path support for Layer 3 user equipment to network relay.

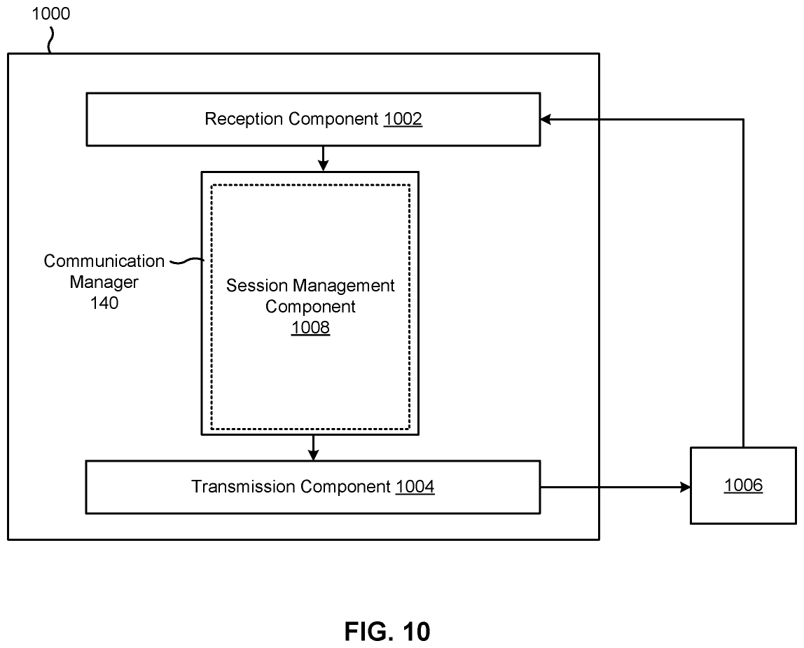

As shown in FIG. 9, in some aspects, process 900 may include receiving an indication to support multiple paths for a PDU session (block 910). For example, the remote wireless communication device (e.g., using communication manager 140 and/or reception component 1002, depicted in FIG. 10) may receive an indication to support multiple paths for a PDU session, as described above.

As further shown in FIG. 9, in some aspects, process 900 may include establishing an MA-PDU session with a network entity over a direct path (block 920). For example, the remote wireless communication device (e.g., using communication manager 140 and/or session management component 1008, depicted in FIG. 10) may establish an MA-PDU session with a network entity over a direct path, as described above.

As further shown in FIG. 9, in some aspects, process 900 may include configuring the MA-PDU session to include an indirect path via a relay wireless communication device and associated with an N3IWF (block 930). For example, the remote wireless communication device (e.g., using communication manager 140 and/or session management component 1008, depicted in FIG. 10) may configure the MA-PDU session to include an indirect path via a relay wireless communication device and associated with an N3IWF, as described above.

As further shown in FIG. 9, in some aspects, process 900 may include communicating via the MA-PDU session (block 940). For example, the remote wireless communication device (e.g., using communication manager 140 and/or transmission component 1004, depicted in FIG. 10) may communicate via the MA-PDU session, as described above.

Process 900 may include additional aspects, such as any single aspect or any combination of aspects described below and/or in connection with one or more other processes described elsewhere herein.

In a first aspect, the indication is received in URSP information indicating whether to support multiple paths for a PDU session.

In a second aspect, alone or in combination with the first aspect, communicating via the MA-PDU session further comprises communicating via the indirect path using a Layer 3 user equipment-to-network relay protocol.

In a third aspect, alone or in combination with one or more of the first and second aspects, the direct path is via a 3GPP access network.

In a fourth aspect, alone or in combination with one or more of the first through third aspects, process 900 includes discovering the relay wireless communication device based at least in part on a sidelink policy of the remote wireless communication device and based at least in part on the relay wireless communication device being associated with a Layer 3 user equipment-to-network relay protocol with N3IWF support, wherein configuring the MA-PDU session to include the indirect path is based at least in part on the discovering the relay wireless communication device.

In a fifth aspect, alone or in combination with one or more of the first through fourth aspects, process 900 includes determining that traffic matches a user equipment route selection policy rule, wherein communicating via the MA-PDU session further comprises communicating via the indirect path based at least in part on a route selection descriptor of the user equipment route selection policy rule.

In a sixth aspect, alone or in combination with one or more of the first through fifth aspects, the route selection descriptor does not indicate to offload communication outside of a PDU session.

In a seventh aspect, alone or in combination with one or more of the first through sixth aspects, process 900 includes receiving ATSSS information associated with the MA-PDU session, wherein communicating via the MA-PDU session further comprises communicating in accordance with the ATSSS information.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a wireless communication device, or a wireless communication device may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include a session management component 1008, among other examples.

In some aspects, the apparatus 1000 may be configured to perform one or more operations described herein in connection with FIGS. 3-8. Additionally, or alternatively, the apparatus 1000 may be configured to perform one or more processes described herein, such as process 900 of FIG. 9, or a combination thereof. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The reception component 1002 may receive an indication to support multiple paths for a PDU session. The session management component 1008 may establish an MA-PDU session with a network entity over a direct path. The session management component 1008 may configure the MA-PDU session to include an indirect path via a relay wireless communication device and associated with an N3IWF. The transmission component 1004 or the reception component 1002 may communicate via the MA-PDU session.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a remote wireless communication device, comprising: receiving an indication to support multiple paths for a protocol data unit (PDU) session; establishing a multi-access PDU (MA-PDU) session with a network entity over a direct path; configuring the MA-PDU session to include an indirect path via a relay wireless communication device and associated with a non-3GPP interworking function (N3IWF); and communicating via the MA-PDU session.

Aspect 2: The method of Aspect 1, wherein the indication is received in user equipment route selection policy (URSP) information indicating whether to support multiple paths for a PDU session.

Aspect 3: The method of any of Aspects 1-2, wherein communicating via the MA-PDU session further comprises: communicating via the indirect path using a Layer 3 user equipment-to-network relay protocol.

Aspect 4: The method of any of Aspects 1-3, wherein the direct path is via a 3GPP access network.

Aspect 5: The method of any of Aspects 1-4, further comprising: discovering the relay wireless communication device based at least in part on a sidelink policy of the remote wireless communication device and based at least in part on the relay wireless communication device being associated with a Layer 3 user equipment-to-network relay protocol with N3IWF support, wherein configuring the MA-PDU session to include the indirect path is based at least in part on the discovering the relay wireless communication device.

Aspect 6: The method of any of Aspects 1-5, further comprising: determining that traffic matches a User equipment route selection policy rule, wherein communicating via the MA-PDU session further comprises: communicating via the indirect path based at least in part on a route selection descriptor of the user equipment route selection policy rule.

Aspect 7: The method of Aspect 6, wherein the route selection descriptor does not indicate to offload communication outside of a PDU session.

Aspect 8: The method of any of Aspects 1-7, further comprising: receiving access traffic steering, switching, and splitting (ATSSS) information associated with the MA-PDU session, wherein communicating via the MA-PDU session further comprises communicating in accordance with the ATSSS information.

Aspect 9: An apparatus for wireless communication at a device, comprising a processor; memory coupled with the processor; and instructions stored in the memory and executable by the processor to cause the apparatus to perform the method of one or more of Aspects 1-8.

Aspect 10: A device for wireless communication, comprising a memory and one or more processors coupled to the memory, the one or more processors configured to perform the method of one or more of Aspects 1-8.

Aspect 11: An apparatus for wireless communication, comprising at least one means for performing the method of one or more of Aspects 1-8.

Aspect 12: A non-transitory computer-readable medium storing code for wireless communication, the code comprising instructions executable by a processor to perform the method of one or more of Aspects 1-8.

Aspect 13: A non-transitory computer-readable medium storing a set of instructions for wireless communication, the set of instructions comprising one or more instructions that, when executed by one or more processors of a device, cause the device to perform the method of one or more of Aspects 1-8.

The foregoing disclosure provides illustration and description but is not intended to be exhaustive or to limit the aspects to the precise forms disclosed. Modifications and variations may be made in light of the above disclosure or may be acquired from practice of the aspects.

Further disclosure is included in the appendix. The appendix is provided as an example only and is to be considered part of the specification. A definition, illustration, or other description in the appendix does not supersede or override similar information included in the detailed description or figures. Furthermore, a definition, illustration, or other description in the detailed description or figures does not supersede or override similar information included in the appendix. Furthermore, the appendix is not intended to limit the disclosure of possible aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A remote wireless communication device, comprising:
a memory; and
one or more processors coupled to the memory and configured to:
receive an indication to support multiple paths for a protocol data unit (PDU) session;
establish a multi-access PDU (MA-PDU) session with a network entity over a direct path;
configure the MA-PDU session to include an indirect path via a relay wireless communication device and associated with a non-3GPP interworking function (N3IWF); and
communicate via the MA-PDU session.

2. The remote wireless communication device of claim 1, wherein the indication is in user equipment (UE) route selection policy (URSP) information indicating whether to support multiple paths for a PDU session.

3. The remote wireless communication device of claim 1, wherein the one or more processors, to communicate via the MA-PDU session, are configured to:
communicate via the indirect path using a Layer 3 user equipment-to-network relay protocol.

4. The remote wireless communication device of claim 1, wherein the direct path is via a 3GPP access network.

5. The remote wireless communication device of claim 1, wherein the one or more processors are configured to:
discover the relay wireless communication device based at least in part on a sidelink policy of the remote wireless communication device and based at least in part on the relay wireless communication device being associated with a Layer 3 user equipment-to-network relay protocol with N3IWF support, wherein configuring the MA-PDU session to include the indirect path is based at least in part on discovering the relay wireless communication device.

6. The remote wireless communication device of claim 1, wherein the one or more processors, to communicate via the indirect path, are configured to communicate via the indirect path based at least in part on a route selection descriptor of a user equipment route selection policy rule that matches traffic of the MA-PDU session.

7. The remote wireless communication device of claim 6, wherein the route selection descriptor does not indicate to offload communication outside of a PDU session.

8. The remote wireless communication device of claim 1, wherein the one or more processors are configured to:
receive access traffic steering, switching, and splitting (ATSSS) information associated with the MA-PDU session, wherein the one or more processors, to communicate via the MA-PDU session, are configured to communicate in accordance with the ATSSS information.

9. A method of wireless communication performed by a remote wireless communication device, comprising:
receiving an indication to support multiple paths for a protocol data unit (PDU) session;
establishing a multi-access PDU (MA-PDU) session with a network entity over a direct path;
configuring the MA-PDU session to include an indirect path via a relay wireless communication device and associated with a non-3GPP interworking function (N3IWF); and
communicating via the MA-PDU session.

10. The method of claim 9, wherein the indication is received in user equipment (UE) route selection policy (URSP) information indicating whether to support multiple paths for a PDU session.

11. The method of claim 9, wherein communicating via the MA-PDU session further comprises:
communicating via the indirect path using a Layer 3 user equipment-to-network relay protocol.

12. The method of claim 9, wherein the direct path is via a 3GPP access network.

13. The method of claim 9, further comprising:
discovering the relay wireless communication device based at least in part on a sidelink policy of the remote wireless communication device and based at least in part on the relay wireless communication device being associated with a Layer 3 user equipment-to-network relay protocol with N3IWF support, wherein configuring the MA-PDU session to include the indirect path is based at least in part on the discovering the relay wireless communication device.

14. The method of claim 9, further comprising:
determining that traffic matches a user equipment route selection policy rule, wherein communicating via the MA-PDU session further comprises:
communicating via the indirect path based at least in part on a route selection descriptor of the user equipment route selection policy rule.

15. The method of claim 14, wherein the route selection descriptor does not indicate to offload communication outside of a PDU session.

16. The method of claim 9, further comprising:
receiving access traffic steering, switching, and splitting (ATSSS) information associated with the MA-PDU session, wherein communicating via the MA-PDU session further comprises communicating in accordance with the ATSSS information.

17. A non-transitory computer-readable medium storing a set of instructions for wireless communication, the set of instructions comprising:
one or more instructions that, when executed by one or more processors of a remote wireless communication device, cause the remote wireless communication device to:
receive an indication to support multiple paths for a protocol data unit (PDU) session;
establish a multi-access PDU (MA-PDU) session with a network entity over a direct path;
configure the MA-PDU session to include an indirect path via a relay wireless communication device and associated with a non-3GPP interworking function (N3IWF); and
communicate via the MA-PDU session.

18. The non-transitory computer-readable medium of claim 17, wherein the indication is received in user equipment route selection policy (URSP) information indicating whether to support multiple paths for a PDU session.

19. The non-transitory computer-readable medium of claim 17, wherein the one or more instructions, that cause the remote wireless communication device to communicate via the MA-PDU session, cause the remote wireless communication device to:
communicate via the indirect path using a Layer 3 user equipment-to-network relay protocol.

20. The non-transitory computer-readable medium of claim 17, wherein the direct path is via a 3GPP access network.

21. The non-transitory computer-readable medium of claim 17, wherein the one or more instructions further cause the remote wireless communication device to:
discover the relay wireless communication device based at least in part on a sidelink policy of the remote wireless communication device and based at least in part on the relay wireless communication device being associated with a Layer 3 user equipment-to-network relay protocol with N3IWF support, wherein configuring the MA-PDU session to include the indirect path is based at least in part on the discovering the relay wireless communication device.

22. The non-transitory computer-readable medium of claim 17, wherein the one or more instructions further cause the remote wireless communication device to:
determine that traffic matches a user equipment route selection policy rule, wherein communicating via the MA-PDU session further comprises:
communicate via the indirect path based at least in part on a route selection descriptor of the user equipment route selection policy rule.

23. The non-transitory computer-readable medium of claim 22, wherein the route selection descriptor does not indicate to offload communication outside of a PDU session.

24. The non-transitory computer-readable medium of claim 17, wherein the one or more instructions further cause the remote wireless communication device to:
receive access traffic steering, switching, and splitting (ATSSS) information associated with the MA-PDU session, wherein communicating via the MA-PDU session further comprises communicating in accordance with the ATSSS information.

25. An apparatus for wireless communication, comprising:
means for receiving an indication to support multiple paths for a protocol data unit (PDU) session;
means for establishing a multi-access PDU (MA-PDU) session with a network entity over a direct path;
means for configuring the MA-PDU session to include an indirect path via a relay wireless communication device and associated with a non-3GPP interworking function (N3IWF); and
means for communicating via the MA-PDU session.

26. The apparatus of claim 25, wherein the indication is in user equipment route selection policy (URSP) information indicating whether to support multiple paths for a PDU session.

27. The apparatus of claim 25, wherein the means for communicating via the MA-PDU session further comprises:
means for communicating via the indirect path using a Layer 3 user equipment-to-network relay protocol.

28. The apparatus of claim 25, wherein the direct path is via a 3GPP access network.

29. The apparatus of claim 25, further comprising:
means for discovering the relay wireless communication device based at least in part on a sidelink policy of the apparatus and based at least in part on the relay wireless communication device being associated with a Layer 3 user equipment-to-network relay protocol with N3IWF support, wherein the means for configuring the MA-PDU session to include the indirect path is based at least in part on the means for discovering the relay wireless communication device.

30. The apparatus of claim 25, further comprising:
means for determining that traffic matches a user equipment route selection policy rule, wherein the means for communicating via the MA-PDU session further comprises:
means for communicating via the indirect path based at least in part on a route selection descriptor of the user equipment route selection policy rule.
